(19) United States
(12) Patent Application Publication
(10) Pub. No.: US 2003/0217002 A1
(43) Pub. Date: Nov. 20, 2003

(54) Method and system for enabling purchase units within a portable device using a mobile vehicle telematics device

(75) Inventor: Kenneth Enborg, Bloomfield Hills, MI (US)

Correspondence Address: ANTHONY LUKE SIMON, General Motors Corporation, Mail Code 482-C23-B21, 300 Renaissance Center, P.O. Box 300, Detroit, MI, 48265-3000, US

(73) Assignee: General Motors Corporation.

(21) Appl. No.: 10/151,427

(22) Filed: May 20, 2002

(51) Int. Cl. G06F 17/60

(52) U.S. Cl. 705/41

(57) ABSTRACT

The invention provides a method for enabling purchase units within a portable device using a mobile vehicle telematics device. Purchase units may be requested through a call center. The requested purchase units may be delivered from the call center to a mobile vehicle telematics device. At least a portion of the purchase units may be transferred from the mobile vehicle telematics device to a portable device. Goods and services may be purchased by sending a signal from the portable device to a transceiver in a place of business transferring an appropriate number of purchase units from the portable device to the place of business.

### FIELD OF THE INVENTION

This invention relates generally to wireless data transmission. More specifically, the invention relates to a method and system for enabling purchase units within a portable device using a mobile vehicle telematics device.

### BACKGROUND OF THE INVENTION

Numerous methods and systems exist for making purchases without using cash. These include bank checks, credit cards, debit cards, and electronic devices such as the Mobil Speedpass and those used for paying tolls on roads or bridges.

Checks, credit cards, and debit cards may be used to purchase a wide variety of goods and services. Credit cards provide centralized billing, which simplifies making payments to multiple sources. Debit cards offer the same convenience of not having to write multiple checks. However, credit cards, debit cards, and checks have the significant disadvantage that either the individual holder of the account or the corporate provider of the service may be at risk of losing large sums of money if cards or checks are lost or stolen and then used by an unauthorized person to purchase goods and services.

Some electronic devices, such as those for paying tolls on roads or bridges, may be purchased with a specific cash value and, therefore, limited liability. However, these devices are also generally quite limited in their uses. Most cannot be used for any purpose other than the single, specified purpose of paying tolls.

Other electronic devices are less limited. For example, the Mobil Speedpass may be used to purchase not only gasoline, but also food and other goods at Mobil convenience stores. It may also be used at some restaurants and additional businesses. However, these purchases are automatically charged to a credit or debit card pre-selected by the holder of the device. Any electronic device with this billing arrangement presents the same risk as a credit or debit card of substantial loss of money if misused.

A method is needed that allows a subscriber to obtain funds within a mobile vehicle anywhere wireless communication services are available and to transfer these funds in increments to a portable device. The method would provide a subscriber with the ability to purchase goods and services when funds are not otherwise available. The method would also limit the amount of funds at risk if the portable device is lost or stolen.

One known method utilizing telematics devices includes purchasing units, downloading the units into the telematics device and using those units to pay for mobile telephone air time (on a pre-paid basis) for mobile calls made through the telematics device.

Therefore, it would be desirable to provide a method and system for enabling purchase units within a portable device using a mobile vehicle telematics device that overcomes the aforementioned and other disadvantages.

### SUMMARY OF THE INVENTION

One aspect of the invention provides a method for enabling purchase units within a portable device using a mobile vehicle telematics device. Purchase units may be requested. The requested purchase units may be delivered from a call center to the mobile vehicle telematics device. At least a portion of the purchase units may be transferred from the mobile vehicle telematics device to a portable device. The purchase units may be decremented from the portable device.

Another aspect of the invention provides a computer-usable medium including a program for enabling purchase units within a portable device using a mobile vehicle telematics device. The program may include computer program code for requesting purchase units, for delivering the purchase units from a call center to the mobile vehicle telematics device, for transferring at least a portion of the purchase units from the mobile vehicle telematics device to a portable device, and for decrementing the purchase units from the portable device.

Yet another aspect of the invention provides a system for enabling purchase units within a portable device using a mobile vehicle telematics device. The system may include means for requesting purchase units, delivering the purchase units from a call center to the mobile vehicle telematics device, transferring at least a portion of the purchase units from the mobile vehicle telematics device to a portable device, and decrementing the purchase units from the portable device.

The aforementioned, and other features and advantages of the invention, will become further apparent from the following detailed description of the presently preferred embodiments, read in conjunction with the accompanying drawings. The detailed description and drawings are merely illustrative of the invention rather than limiting, the scope of the invention being defined by the appended claims and equivalents thereof.

### BRIEF DESCRIPTION OF THE DRAWINGS

FIG. 1 is an illustration of one embodiment of a system for enabling purchase units within a portable device using a mobile vehicle telematics device, in accordance with the current invention; and

FIG. 2 is a flow diagram of one embodiment of a method for enabling purchase units within a portable device using a mobile vehicle telematics device, in accordance with the current invention.

### DETAILED DESCRIPTION OF THE PRESENTLY PREFERRED EMBODIMENTS

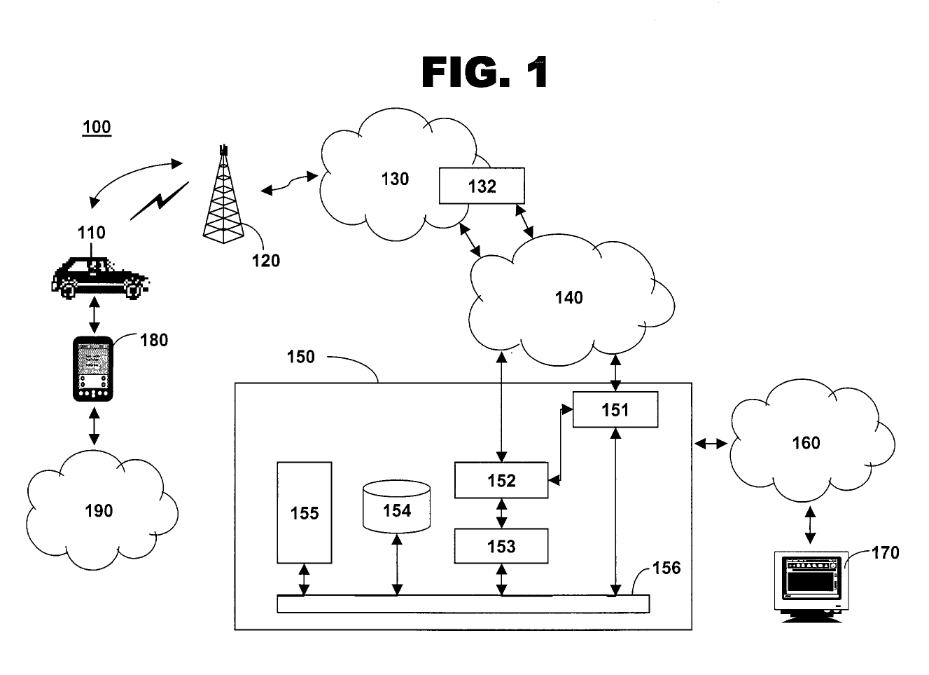

FIG. 1 shows an illustration of one embodiment of a system for enabling purchase units within a portable device using a mobile vehicle telematics device, in accordance with the present invention at 100.

Purchase unit enabling system 100 may contain one or more mobile vehicles 110, one or more wireless carrier systems 120, one or more communication networks 130, one or more short message service centers 132, one or more land networks 140, one or more call centers 150, one or more Web sites 160, one or more Internet access devices 170, one or more portable networking devices 180, and one or more transceivers in a place of business 190. Call center 150 may contain one or more switches 151, one or more data transmission devices 152, one or more communication services managers 153, one or more communication services databases 154, one or more advisors 155, and one or more bus systems 156.

Mobile vehicle 110 may contain a wireless vehicle communication device, such as an analog or digital phone with suitable hardware and software for transmitting and receiving data communications. The suitable hardware may include one or more microphones and one or more speakers, which may be used for communicating with call center 150. The speakers may also be used to deliver system messages, for example notification that less than a specified minimum number of purchase units remain.

Mobile vehicle 110 may contain a global positioning system (GPS) unit capable of determining synchronized time and a geophysical location of the mobile vehicle.

Mobile vehicle 110 may contain a telematics device including multiple components. The telematics device may receive and store purchase units.

Mobile vehicle 110 may contain a wireless modem for transmitting and receiving data. The data may encode, for example, a specific quantity of requested purchase units.

Mobile vehicle 110 may contain a digital signal processor with software and additional hardware to enable communications with the mobile vehicle and to perform other routines and requested services. The additional hardware may include a wireless transceiver capable of receiving data from and transmitting data to a portable device 180. The wireless transceiver may use, for example, Bluetooth technology operating in the unlicensed Industrial Scientific-Medical (ISM) frequency band at 2.4 GHz, or IrDA (Infrared Data Association) standard infrared transmissions at a nominal wavelength of 875 nm, or any other appropriate technology. A routine performed by the digital signal processor may be, for example, delivering requested purchase units from call center 150 to mobile vehicle 110 or transferring purchase units from the vehicle to portable device 170.

Mobile vehicle 110 may send radio transmissions to and receive radio transmissions from wireless carrier system 120. Wireless carrier system 120 may be a wireless communications carrier. Wireless carrier system 120 may be, for example, a mobile telephone system. The mobile telephone system may be an analog mobile telephone system operating over a prescribed band nominally at 800 MHz. The mobile telephone system may be a digital mobile telephone system operating over a prescribed band nominally at 800 MHz, 900 MHz, 1900 MHz, or any suitable band capable of carrying mobile communications. Wireless carrier system 120 may transmit to and receive signals from mobile vehicle 110. Wireless carrier system 120 may transmit to and receive signals from a second mobile vehicle 110. Wireless carrier system 120 may be operably connected with communications network 130.

Communications network 130 may comprise a mobile switching center. Communications network 130 may comprise services from one or more wireless communications companies. Communications network 130 may be any suitable system or collection of systems for connecting wireless carrier system 120 to a second mobile vehicle 110 or to a call center.

Communications network 130 may include one or more short message service centers 132. Short message service center 132 may prescribe alphanumeric short messages to and from mobile vehicles 110. Short message service center 132 may include message entry features, administrative controls, and message transmission capabilities. Short message service center 132 may store and buffer the messages. Short message services may include functional services such as paging, text messaging and message waiting notification. Short message services may include other telematic services such as broadcast services, time-driven message delivery, autonomous message delivery, and database-driven information services. The telematic services may further include message management features, such as message priority levels, service categories, expiration dates, cancellations, and status checks.

Land network 140 may be a public-switched telephone network. Land network 140 may comprise a wired network, an optical network, a fiber network, another wireless network, or any combination thereof. Land network 140 may comprise an Internet protocol (IP) network. Land network 140 may connect communications network 130 to a call center.

Land network 140 may connect a first wireless carrier system 120 with a second wireless carrier system 120. Communication network 130 and land network 140 may connect wireless carrier system 120 to a communication node or call center 150. The communication delivered to the call center may be, for example, a request for purchase units.

Call center 150 may be a location where many calls may be received and serviced at the same time, or where many calls may be sent at the same time. The call center may be a telematics call center, prescribing communications to and from mobile vehicles 110. The call center may be a voice call center, providing verbal communications between an advisor in the call center and a subscriber in a mobile vehicle. The call center may contain each of these functions.

The call center 150 may contain switch 151. Switch 151 may be connected to land network 140 and may receive a modem signal from an analog modem or from a digital modem. Switch 151 may transmit voice or data transmission from a communication node. Switch 151 may also receive voice or data transmissions from mobile vehicle 110 through wireless carrier system 120, communications network 130, and land network 140. Switch 151 may receive from or send data transmissions to data transmission device 152. Switch 151 may receive from or send voice transmissions to advisor 155 via bus system 156.

Data transmission device 152 may send or receive data from switch 151. Data transmission device 152 may be an IP router or a modem. Data transmission device 152 may transfer data to or from advisor 155, one or more communication services managers 153, one or more communication services databases 154, and any other device connected to bus system 156. Data transmission device 152 may convey information received from communication network 130 to communication services manager 153.

Communication services manager 153 may be connected to switch 151, data transmission device 152, and advisor 155 through bus system 156. The call center may contain any combination of hardware or software facilitating data transmissions between call center 150 and mobile vehicle 110 and between call center 150 and Web site 160.

Communication services manager 153 may receive information from mobile vehicle 110 through wireless carrier system 120, communication network 130, land network 140, and data transmission device 152. Communication services manager 153 may send information to mobile vehicle 110 through data transmission device 152, land network 140, communication network 130, and wireless carrier system 120. Communication services manager 153 may provide information to mobile vehicle 110 from communication services database 154.

Communication services database 154 may contain records on one or more mobile vehicles 110. Records in communication services database 154 may include vehicle identification, location information, status information, and recent action information regarding mobile vehicle 110. Communication services database 154 may also contain information regarding limited-duration events. Communication services database 154 may provide information and other support to communication services manager 153.

Advisor 155 may be a real advisor or a virtual advisor. A real advisor may be a human being in verbal communication with the mobile communication device of vehicle 110. A virtual advisor may be a synthesized voice interface responding to requests from the mobile communication device of vehicle 110. Advisor 155 may provide services to the mobile communication device of vehicle 110. A service provided by advisor 155 may be responding to a request for delivery of purchase units. Advisor 155 may communicate with communication services manager 153 or any other device connected to bus system 156.

Call center 150 may receive information from Web site 160. The information received from Web site 160 may be, for example, a request for purchase units that a subscriber entered through the Web site.

Internet access device 170 may be, for example, a personal computer. The personal computer may contain software, for example a Web browser, that enables it to connect with Web site 160.

Portable device 180 may be for example, a personal data assistant (PDA), a cellular phone with memory capability, a vehicle key fob, or any other appropriate device. Portable device 180 may contain a wireless transceiver capable of communicating both with a transceiver in mobile vehicle 110 and with a transceiver in a place of business 190.

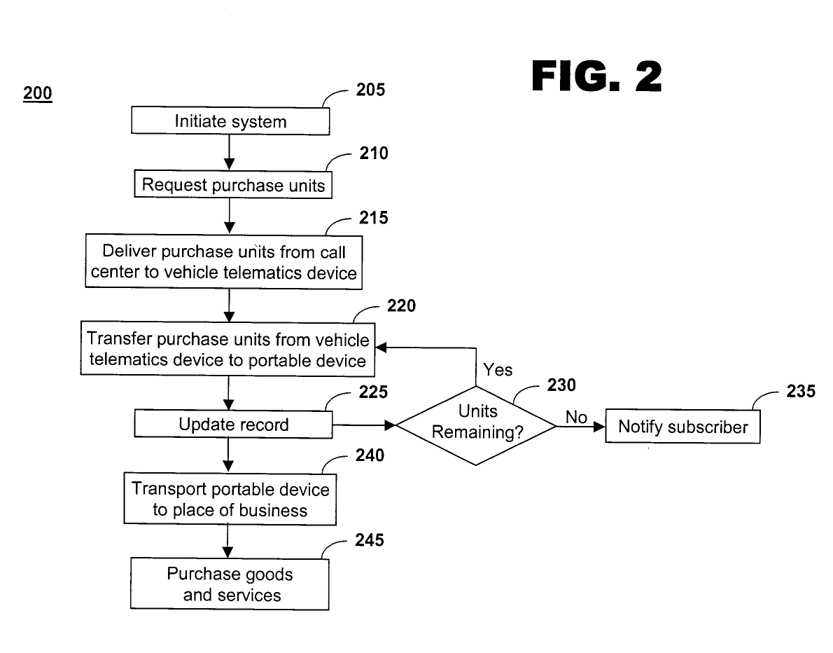

FIG. 2 shows a flow diagram of one embodiment of a method for enabling purchase units within a portable device using a mobile vehicle telematics device, in accordance with the present invention at 200. Method 200 comprises steps to request purchase units, deliver the purchase units from a call center to a mobile vehicle telematics device, transfer at least a portion of the purchase units from the mobile vehicle telematics device to a portable device, and decrement purchase units from the portable device.

A wireless communication services subscriber may initiate the system shown in FIG. 1. This may be accomplished by the subscriber pressing a button inside the vehicle 110 (Block 205).

The subscriber may request purchase units (Block 210) by issuing a voice command to advisor 155 in call center 150. Advisor 155 may be a human being in verbal communication with the mobile communication device of vehicle 110 or a synthesized voice interface. Alternatively, the subscriber may request purchase units through a dedicated Web site 160 associated with call center 150.

Call center 150 may deliver data encoding the requested number of purchase units to a telematics device within the vehicle 110 (Block 215). The subscriber may transfer at least a portion of the purchase units from the vehicle telematics device to a portable device 180, for example to a personal data assistant (PDA) or other suitable portable device (block 220).

As purchase units are transferred from the vehicle telematics device to the portable device, the vehicle telematics device may update the record of purchase units remaining (block 225). If less than a specified minimum number of purchase units remain (block 230), the vehicle telematics device may notify the subscriber, for example by issuing an audible warning, that the purchase units need to be replenished (block 235).

The subscriber may transport the portable device containing the encoded purchase units from vehicle 110 to a place of business (block 240). The subscriber may then purchase goods and services by transferring the appropriate number of purchase units through a transceiver in portable device 180 to a transceiver in the place of business 190 (block 245).

In practice, the described method may be used by a subscriber to enable purchase units within a mobile vehicle anywhere the vehicle's wireless communication service operates and bill the purchase units to the subscriber's service account. The method may provide access to funds when a subscriber's wallet has been lost or stolen or when the subscriber is not near a bank or automatic teller machine. The method may also provide a convenient way of paying for purchases without the need to carry cash, write a check, or use a credit or debit card. Because the method offers the option of transferring to the portable device only a portion of the purchase units stored in the vehicle telematics device, it provides the benefits of centralized billing while also limiting the amount of funds at risk if the portable device is lost or stolen

While the embodiments of the invention disclosed herein are presently considered to be preferred, various changes and modifications can be made without departing from the spirit and scope of the invention. The scope of the invention is indicated in the appended claims, and all changes that come within the meaning and range of equivalents are intended to be embraced therein.

1. A method for enabling purchase units within a portable device using a mobile vehicle telematics device, comprising:
requesting purchase units;
delivering the purchase units from a call center to the mobile vehicle telematics device;
transferring at least a portion of the purchase units from the mobile vehicle telematics device to a portable device; and
decrementing purchase units from the portable device.

2. The method of claim 1 wherein the purchase units are requested through one of a call center or a Web site associated with a call center.

3. The method of claim 1 wherein decrementing purchase units from the portable device comprises purchasing goods and services.

4. The method of claim 3 wherein purchasing goods and services comprises sending a signal from the portable device to a transceiver in a place of business transferring an appropriate number of purchase units from the portable device to the transceiver in the place of business.

5. The method of claim 1 further comprising:
maintaining an updated record of the number of purchase units remaining within the mobile vehicle telematics device.

6. The method of claim 5 further comprising:
notifying a subscriber of the number of purchase units remaining within the mobile vehicle telematics device each time purchase units are transferred from the mobile vehicle telematics device to the portable device.

7. The method of claim 5 further comprising:
notifying a subscriber when less than a specified number of purchase units remain within the mobile vehicle telematics device.

8. A computer-usable medium for enabling purchase units within a portable device using a mobile vehicle telematics device, comprising:
computer program code for requesting purchase units;
computer program code for delivering the purchase units from a call center to the mobile vehicle telematics device;
computer program code for transferring at least a portion of the purchase units from the mobile vehicle telematics device to a portable device; and
computer program code for decrementing purchase units from the portable device.

9. The computer-usable medium of claim 8 wherein the purchase units are requested through one of a call center or a Web site associated with a call center.

10. The computer-usable medium of claim 8 wherein decrementing purchase units from the portable device comprises purchasing goods and services.

11. The computer-usable medium of claim 10 wherein purchasing goods and services comprises sending a signal from the portable device to a transceiver in a place of business transferring an appropriate number of purchase units from the portable device to the transceiver in the place of business.

12. The computer-usable medium of claim 8 further comprising:
computer program code for maintaining an updated record of the number of purchase units remaining within the mobile vehicle telematics device.

13. The computer-usable medium of claim 8 further comprising:
computer program code for notifying a subscriber of the number of purchase units remaining within the mobile vehicle telematics device each time purchase units are transferred from the mobile vehicle telematics device to the portable device.

14. The computer-usable medium of claim 8 further comprising:
computer program code for notifying a subscriber when less than a specified number of purchase units remain within the mobile vehicle telematics device.

15. A system for enabling purchase units within a portable device using a mobile vehicle telematics device, comprising:
means for requesting purchase units;
means for delivering the purchase units from a call center to the mobile vehicle telematics device;
means for transferring at least a portion of the purchase units from the mobile vehicle telematics device to a portable device; and
means for decrementing purchase units from the portable device.

16. The system of claim 15 wherein the purchase units are requested through one of a call center or a Web site associated with a call center.

17. The system of claim 15 wherein decrementing purchase units from the portable device comprises purchasing goods and services.

18. The system of claim 17 wherein purchasing goods and services comprises sending a signal from the portable device to a transceiver in a place of business transferring an appropriate number of purchase units from the portable device to the transceiver in the place of business.

19. The system of claim 15 further comprising:
means for maintaining an updated record of the number of purchase units remaining within the mobile vehicle telematics device.

20. The system of claim 15 further comprising:
means for notifying a subscriber of the number of purchase units remaining within the mobile vehicle telematics device each time purchase units are transferred from the mobile vehicle telematics device to the portable device.

21. The system of claim 15 further comprising:
means for notifying a subscriber when less than a specified number of purchase units remain within the mobile vehicle telematics device.
